(19) United States
(12) Patent Application Publication
(10) Pub. No.: US 2016/0205611 A1
(43) Pub. Date: Jul. 14, 2016

(54) CONTROL APPARATUS AND METHOD OF BASE STATION

(71) Applicant: FUJITSU LIMITED, Kawasaki-shi (JP)

(72) Inventors: Noboru Kobayashi, Tokorozawa (JP); Tadashi Nakamura, Yokohama (JP)

(73) Assignee: FUJITSU LIMITED, Kawasaki-shi (JP)

(21) Appl. No.: 14/992,221

(22) Filed: Jan. 11, 2016

(30) Foreign Application Priority Data
Jan. 13, 2015 (JP) 2015-004472

(51) Int. Cl. H04W 40/12

(52) U.S. Cl. CPC H04W 40/12

(57) ABSTRACT

A control apparatus of a base station includes a controller to execute a process of measuring delay time of a signal in a predetermined route segment of a communication route between a radio apparatus and a baseband apparatus to process the signal coming from the radio apparatus, and a process of determining at least one of a protocol and a specification used for the communication between the baseband apparatus and the radio apparatus, corresponding to the delay time.

### CROSS-REFERENCE TO RELATED APPLICATION

This application is based upon and claims the benefit of priority of the prior Japanese Application No. 2015-004472 filed on Jan. 13, 2015, the entire contents of which are incorporated herein by reference.

### FIELD

The present disclosure pertains to a control apparatus of a base station, and a control method of a base station.

### BACKGROUND

There is a wide spread of wireless communications based on a cellular system, such as Wideband Code Division Multiple Access (WCDMA), Long Term Evolution (LTE), etc. Base stations of the wireless communications are disposed on communication areas.

One of the base stations is a base station including Remote Radio Unit (RRU) and Base Band Unit (BBU). The RRU handles radio signals transmitted and received to and from a radio terminal (User Equipment (UE)). The BBU handles baseband signals. The RRU radiates radio waves to form a cell used to perform wireless communications with UEs. The BBU is connected to a core network (it is called “Evolved Packet Core (EPC)” in LTE) apparatus. The core network apparatus is connected to a Packet Data Network (PDN).

The RRU converts the radio signals received from the UE into baseband signals, while the BBU converts the baseband signal into packets. Each packet is transmitted to the PDN via the core network (the core network apparatus). The PDN is connected to the Internet or other equivalent networks, and the packet arrives at a destination host connected to, e.g., the Internet.

For further information, see Japanese Laid-Open Patent Publication No. 2014-128024, Japanese Laid-Open Patent Publication No. 2013-243524, Japanese National Publication of International Patent Application No. 2013-503533, and Japanese National Publication of International Patent Application No. 2014-514848.

In standards for wireless communications such as the LTE, a period of time for the BBU responding to a processing target signal received from the RRU is predetermined. Consequently, a length of a communication route between the BBU and the RRU increases, and, when delay time elongates, such a possibility arises that the processing of the processing target signal is not finished during the predetermined period of time.

### SUMMARY

One of aspects is a control apparatus of a base station, including a controller configured to execute a process including measuring delay time of a signal in a predetermined route segment of a communication route between a radio apparatus and a baseband apparatus to process the signal coming from the radio apparatus, and determining at least one of a protocol and a specification used for the communication between the baseband apparatus and the radio apparatus in response to the delay time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of configuration of a network system including BBUs and RRUs;

FIG. 2 is a diagram illustrating an example of configuration of the network system to which a CBBU is applied;

FIG. 3 is a diagram illustrating an example of configuration of the network system configured to distribute loads among CBBUs;

FIG. 4 is a diagram illustrating an example of configuration of a network system according to an embodiment;

FIG. 5 is a diagram illustrating an example of a configuration of a CBBU operable as one of CBBU#1-CBBU#4 and an example of a configuration of the RRU operable as each RRU;

FIG. 6 is a diagram illustrating an example of a hardware configuration of an information processing apparatus (computer) operable as the controller;

FIG. 7 is a diagram schematically illustrating functions of the controller;

FIG. 8 is a diagram illustrating an example of a data structure of a table;

FIG. 9 is a diagram illustrating an example of how processing time is ensured by TTI relaxation;

FIG. 10 is an explanatory diagram of load reduction of the signal processing obtained by a change of a CP length;

FIG. 11 is a diagram illustrating an operational example in the network system according to the embodiment illustrated in FIG. 4;

FIG. 12 is a sequence diagram illustrating an operational example of the embodiment;

FIG. 13 is a flowchart illustrating a processing example of the controller;

FIG. 14 is a flowchart illustrating one example of a protocol selection process depicted in FIG. 13;

FIG. 15 is a diagram illustrating a modified example 1 of the embodiment; and

FIG. 16 is a sequence diagram illustrating a modified example 2 of the embodiment.

### DESCRIPTION OF EMBODIMENTS

An embodiment will hereinafter be described with reference to the drawings. A configuration of the following embodiment is an exemplification, and the present invention is not limited to the configuration of the embodiment.

### Related Technology

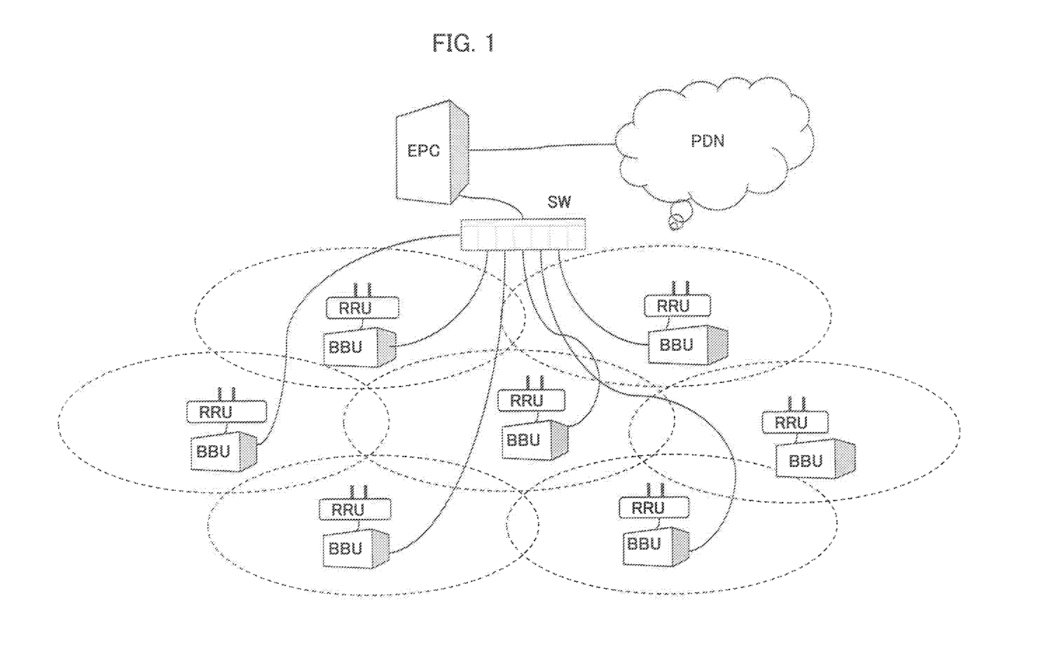

To start with, a related technology of a network system according to the embodiment will be described. FIG. 1 illustrates an example of configuration of a network system including BBUs and RRUs. As illustrated in FIG. 1, the BBU and the RRU connected to the BBU are paired, and each BBU is connected to an EPC apparatus via a switch (SW). The EPC apparatus is connected to a PDN.

The network configuration as depicted in FIG. 1 is adopted, in which case the BBU is designed to guarantee an ability enabling the BBU to perform a normal operation even when an assumed maximum load is applied. As a matter of course, an actual operation is performed in a range lower than the maximum load by taking a countermeasure (e.g., the processing is restricted when a congestion is presumed) not to cause a system down of the BBU. In a daily operation, the BBU ordinarily has a much lower load than its ability has and is in a status of having futile process resources.

It is considered to introduce a CBBU (Centralized Base Band Unit) enabling the process resources to be efficiently used by aggregating baseband processes of a plurality of cells in order to reduce the futile process resources.

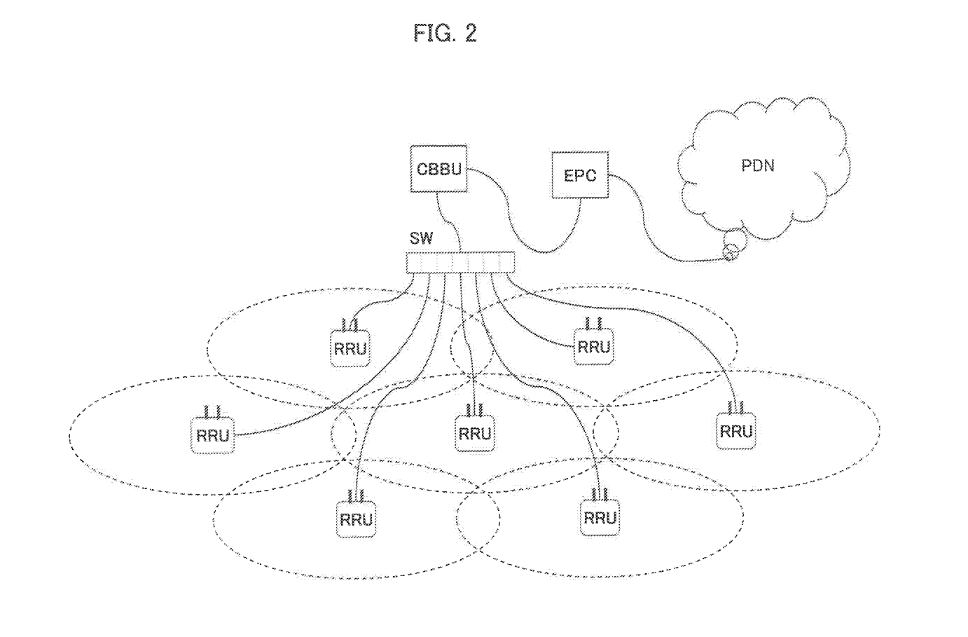

FIG. 2 is a diagram illustrating an example of configuration of a network system to which the CBBU is applied. The plurality of RRUs is connected to the CBBU via the switch (SW). The process resources on the CBBU are used in response to requests from the cell(s). A maximum process quantity of an n-number of cells (which is given by a “per cell maximum process quantity X “n”) connected to the CBBU is not required to be prepared, and it is therefore considered to prepare the CBBU process resource quantity smaller than the maximum process quantity.

However, a case of preparing the process resources smaller than the maximum process quantity has a risk of causing a high load state that occurs rarely and a deficiency of the process resources when a failure occurs in a part of the CBBU process resources.

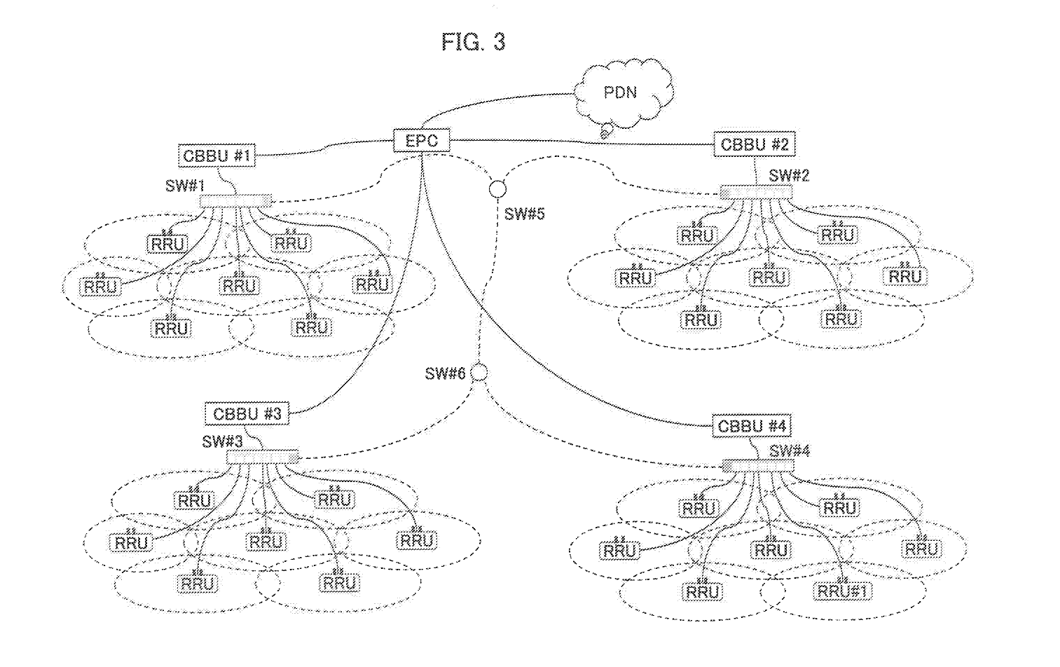

Hence, it is considered to avoid the risk by sharing the process resources and distributing the loads among the CBBUs. For example, FIG. 3 illustrates network system configuration to distribute the loads among the CBBUs. As depicted in FIG. 3, a plurality of CBBU#1-CBBU#4 each accommodating the plurality of RRUs via the switches (SW#1-SW#4) are provided, and the switches (SW#1-SW#4) are interconnected via switches (SW#5, SW#6). Connecting relationships between the CBBUs and the RRUs may be changed by switch control. For example, a process(es) pertaining to the RRU#1 subordinating to a given CBBU (e.g., CBBU#4) at a normal time is executed by another CBBU (e.g., CBBU#1).

However, a length of cables for connecting between the switches increases in order for one CBBU to cover a broad geographical range. Consequently, when the RRU#1 is connected to another CBBU#1 by the change of the connecting relationship, a period of delay time (transmission delay time of the signal) between the RRU#1 and the CBBU#1 elongates. A period of time till the CBBU gives a response to the signal since receiving the signal from the RRU, is predetermined based on the Standards of wireless communications (3GPP, and other equivalent standards). Therefore, the increase in delay time between the CBBU and the RRU implies a decrease in time usable for the CBBU to process the signals. This may lead to a possibility that the CBBU#1 cannot finish processing the signals received from the RRU#1 within a requested period of time.

It is considered to provide the CBBU with a high processing ability against the decrease in processing time due to the increase in delay time (to speed up an operating clock or parallelize the signal processing). A method of enhancing the processing ability, however, brings rises in cost and in power consumption of the CBBU apparatus. Alternatively, the enhanced processing ability is hard to attain as the case may be.

The CBBU rarely receives a much larger processing load than an average processing load. It therefore leads to the rises in cost and in power consumption that the CBBU has high performance against an emergency load. A method is therefore demanded, which can handle the distribution of the emergency load while restraining the rise in cost.

The embodiment to be demonstrated as below, will discuss the network system enabling the BBU to finish processing the signals coming from the RRUs within the requested time.

### Embodiment

The network system according to the embodiment will hereinafter be described. The embodiment discusses a case of adopting the LTE as one of the standards for wireless communications. The LTE is not, however, an indispensable requirement for the standards, and claimed inventions may be applied to network systems that support other Standards for wireless communications.

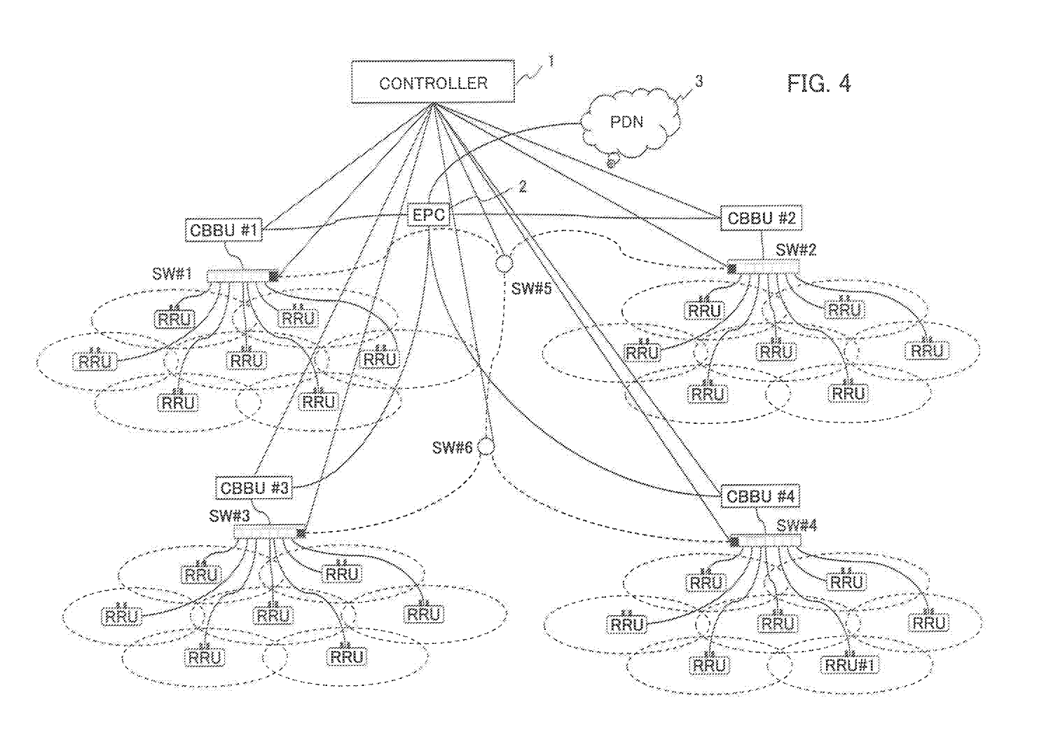

FIG. 4 illustrates an example of configuration of a network system according to the embodiment. The network system includes a plurality of base stations. Each base station includes a plurality of RRUs and CBBUs each accommodating the plurality of RRUs via a switch. FIG. 4 illustrates the example of having the switches SW#1-SW#4 each connected to the plurality of RRUs. The switch SW#1 is connected to the CBBU#1; the switch SW#2 is connected to the CBBU#2; the switch SW#3 is connected to the CBBU#3; and the switch SW#4 is connected to the CBBU#4. The switches SW#1-SW#4 are configured to be interconnectable via relay paths (depicted by broken lines in FIG. 4) including the switches SW#5 and SW#6. In other words, the plurality of base stations is interconnected via the relay paths. The CBBU is one example of a “baseband apparatus”, and the RRU is one example of a “radio apparatus”.

Each of the CBBU#1-CBBU#4 is connected to an EPC apparatus 2, and the EPC apparatus 2 is connected to a PDN 3. Each RRU radiates radio waves, thereby forming the cell (indicated by a circle depicted by a broken line in the drawings throughout). The RRU performs the wireless communications with a radio terminal (User Equipment: UE) existing within the cell. The RRU converts the radio signals received from the UE into baseband signals, thus outputting the baseband signals.

The CBBU receives the baseband signals output from the RRU via the switch, and executes a process for the baseband signals. The CBBU outputs the baseband signals directed to the UE. The RRU receives the baseband signals via the switch via the switch, then converts the baseband signals into the radio signals, and transmits (radiates) the radio signals.

The network system includes a control apparatus (controller) 1 for the base station. The controller 1 is connected to the CBBU#1-CBBU#4, and can control the operation of each CBBU. The controller 1 is connected to the SW#1-SW#6, and performs the control to change an output port of the signals inputted from each RRU. The controller 1 is thereby enabled to control each SW so that the signals from the respective RRUs reach the desired CBBU.

The controller 1 conducts the control to change the output ports of the signals inputted from the CBBUs with respect to the SW#1-SW#5. This control enables the signals output from the respective CBBUs to reach the desired RRUs through the switch control.

For example, a group of RRUs connected to any one of the SW#1-SW#4 are connected to any one of the CBBU#1-CBBU#4 connected to the SW#1-SW#4 at the normal time. To be specific, the group of RRUs connected to the SW#1 are connected to the CBBU#1 via the SW#1 (the RRUs being subordinate to the CBBU#1). The group of RRUs connected to the SW#2 are connected to the CBBU#2 via the SW#2 (the RRUs being subordinate to the CBBU#2). The group of RRUs connected to the SW#3 are connected to the CBBU#3 via the SW#3 (the RRUs being subordinate to the CBBU#3). The group of RRUs connected to the SW#4 are connected to the CBBU#4 via the SW#4 (the RRUs being subordinate to the CBBU#4).

The SW#1-SW#4 include the output ports for outputting the signals to other SWs (each port serving to change over a given RRU to the subordinate to another CBBU). With this contrivance, when the load on a given CBBU rises, the load can be distributed to another CBBU. To be specific, such a case may arise that a given CBBU (e.g., the CBBU#4) is disabled from processing the signals transmitted from the RRU (RRU#1) subordinate to the CBBU#4 for a reason instanced by a temporary rise in load. In this case, the controller 1 controls the SW so that another CBBU capable of processing the signals from the RRU#1 receives the signals from the RRU#1.

In other words, the controller 1 controls the operations of the SW#4, SW#5, SW#6 and SW#1 so that the signals from the RRU#1 reach the CBBU#1 and the signals from the CBBU#1 reach the RRU#1. The controller 1 controls the operation of the CBBU#1 to process the signals from the RRU#1.

### Examples of Configurations of CBBU and RRU

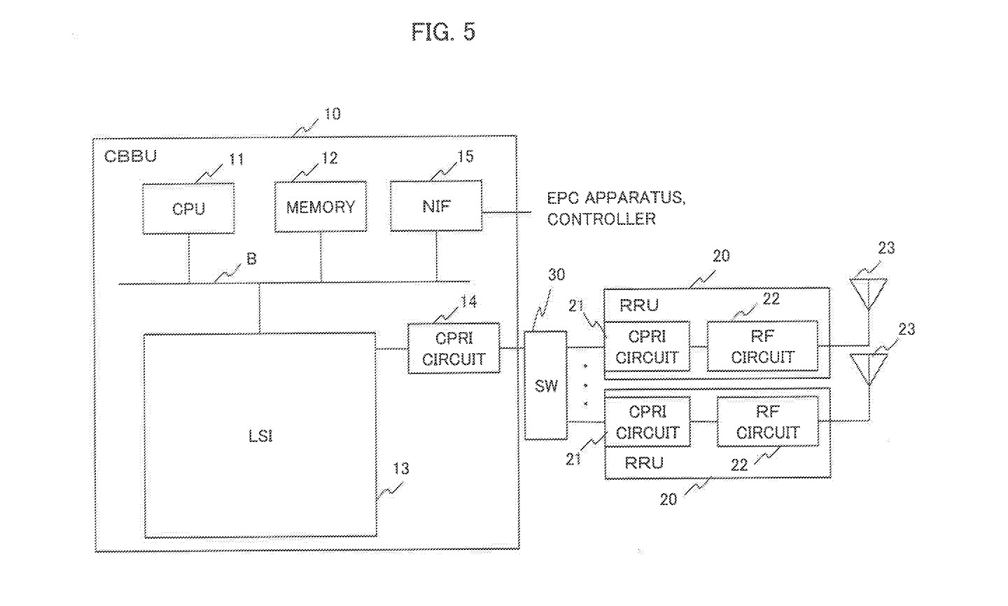

FIG. 5 illustrates an example of a configuration of a CBBU 10 operable as one of the CBBU#1-CBBU#4 and an example of a configuration of an RRU 20 operable as each RRU. The CBBU 10 is an apparatus that operates as a control unit, a baseband unit and a transmission path interface unit of the base station (e.g., eNodeB of the LTE).

The control unit controls the whole CBBUs, executes a call control protocol process, and performs control monitoring. The transmission path interface unit is connected to a transmission path instanced by Ethernet (registered trademark), and receives and transfers an IPpacket by executing an IPsec or IPv6 protocol process. The baseband unit converts (modulates and demodulates) the IP packet received and transferred via the transmission path interface unit and the baseband signals to be transmitted wirelessly.

In FIG. 5, the CBBU 10 includes a Central Processing Unit (CPU) 11, a memory 12, an Large Scale Integrated circuit (LSI) 13, a Common Public Radio Interface (CPRI) circuit 14, and an Network Interface (NIF) 15, which are interconnected via a bus B.

The memory 12 is one example of a “storage device (storage)” and a “non-transitory computer readable recording medium”. The memory 12 includes a main storage device (main storage) and an auxiliary storage device (auxiliary storage). The main storage device is used as a work area for the CPU 11. The main storage device is configured by e.g., a Random Access Memory (RAM) or a combination of the RAM and a Read Only Memory (ROM).

The auxiliary storage device stores programs to be run by the CPU 11, and data used for the CPU 11 to run the programs. At least one of, e.g., an Hard Disk Drive (HDD), an Solid State Drive (SSD), a flash memory and an Electrically Erasable Programmable Read-Only Memory (EEPROM) is selected as the auxiliary storage device. The auxiliary storage device may include a non-transitory disk storage medium instanced by a CD, a DVD, a Blu-ray disc and other equivalent storage mediums.

The LSI 13 is configured by using a general-purpose LSI, e.g., an Application Specific Integrated Circuit (ASIC). The LSI 13 may include a Programmable Logic Device (PLD) such as a Field Programmable Gate Array (FPGA). The LSI 13 includes a Digital Signal Processor (DSP) as the case may be.

The LSI 13 is an integrated circuit operating as the baseband processing unit described above. The LSI 13 executes the converting process for the IP packet and the baseband signals with respect to signals on a User plane (U-plane). The LSI 13 executes a process of handing over, to the CPU 11, the baseband signals received from the UE and a control signal obtained from the IP packet received from a core network (the EPC apparatus 2) or another base station (neighboring base station). While on the other hand, the LSI 13 executes a process of converting the control signal obtained from the CPU 11 into the IP packet directed to the core network (the EPC apparatus 2) and another base station, and into the baseband signals directed to the UE.

The NIF 15 is an interface circuit or an interface device operating as the transmission path interface unit. The NIF 15 receives the transmission path like Ethernet (LAN) and connects to the EPC apparatus 2 and another communication apparatus instanced by the neighboring base station via the transmission path to execute a process of transmitting and receiving the IP packet between these communication apparatuses. For example, a LAN card or a Network Interface Card (NIC) may be applied to the NIF 15.

The CPRI circuit 14 is an interface circuit with the RRU, which supports Common Public Radio Interface (CPRI) defined as one of the standard Interface between the BBU and the RRU. The CPRI circuit 14 is connected via the switch (SW) 30 to the RRU 20 by use of an optical fiber or a metal cable. The SW 30 corresponds to each of the SW#1-SW#4 illustrated in FIG. 4, and receives the plurality of RRUs 20.

The CPRI circuit 14 converts the baseband signals directed to the corresponding RRU into signals having a signal format based on the CPRI (which are called “CPRI signals”), and transmits the CPRI signals to the RRU 20. The CPRI circuit 14 converts the CPRI signals received from the corresponding RRU 20 via the SW 30 back into the baseband signals, and inputs the baseband signals to the LSI 13. The SW 30 sends the inputted signals from the output port corresponding to information of an output destination, based on the information of the output destination of the signals inputted from the controller 1.

The CPU 11 loads the program stored in the auxiliary storage device 13 into the main storage device, and runs the program. With this program, the CPU 11 operates as the control unit described above. The CPU 11 is one example of a “processor” or a “control apparatus”. A concept of the “processor” encompasses a microprocessor (Micro Processing Unit: MPU) and the DSP. Processes to be executed by the CPU 11 may also be executed by a hardware logic using, e.g., the integrated circuit. For example, the processes to be executed by the CPU 11 may also be executed by the LSI 13.

The RRU 20 is an apparatus functioning as a radio unit of the eNodeB. The RRU 20 includes a CPRI circuit 21, an RF (Radio Frequency) circuit 22 and an antenna 23. The CPRI circuit 21 converts the CPRI signals received from the CPRI circuit 14 via the SW 30 back into the baseband signals, and sends the baseband signals to the RF circuit 22. The CPRI circuit 21 converts the baseband signals from the RF circuit 22 into the CPRI signals, and sends the CPRI signals to the CPRI circuit 14 (SW 30).

The RF circuit 22 includes, e.g., a modulation/demodulation circuit, an up-converter, a Power Amplifier (PA), a duplexer, a Low Noise Amplifier (LNA) and a down-converter. The duplexer is connected to the antenna 23 serving as a transmission/reception antenna.

The modulation/demodulation circuit modulates the baseband signals from the CPRI circuit 21 into analog signals, demodulates the analog signals coming from the down-converter into the baseband signals, and sends the baseband signals to the CPRI circuit 21. The up-converter up-converts the analog signals modulated by the modulation/demodulation circuit into signals having a predetermined radio frequency (RF). The PA amplifies the up-converted signals. The amplified signals are radiated as radio waves from the antenna 23 via the duplexer. The UE in the cell receives the radio waves.

The antenna 23 receives the radio signals from the subordinate UEs. The duplexer connects to the LNA. The LNA low-noise amplifies the radio signals. The down-converter down-converts the low-noise-amplified signals into the analog signals. The modulation/demodulation circuit converts the analog signals into the baseband signals by a demodulation process of the analog signals, and sends the baseband signals to the CPRI circuit 21.

Note that the example given above describes how the CPRI signals are transmitted and received between the CBBU and the RRU. This operation may be replaced by performing packet communications between the CBBU and the RRU. In this case, the packet containing the signals directed to the RRU is transmitted not from the CPRI circuit 14 but from the NIF 15 in the CBBU. The RRU includes the NIF for transmitting and receiving the packet to and from the CBBU.

### Example of Configuration of Controller

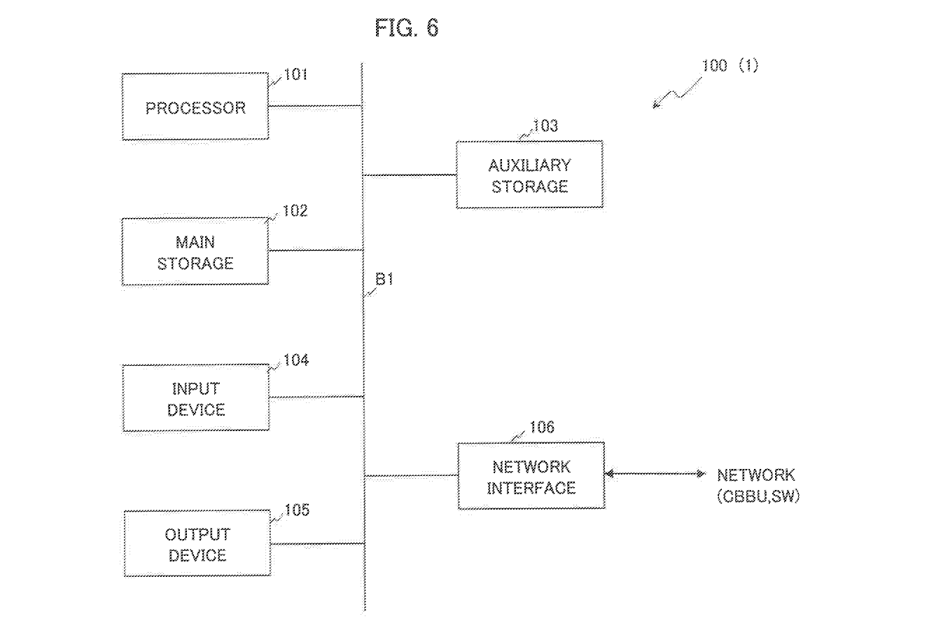

FIG. 6 is a diagram illustrating an example of a hardware configuration of an information processing apparatus (computer) operable as the controller 1. For example, a dedicated server machine or a general-purpose computer (instanced by a personal computer (PC) and a workstation) can be applied to an information processing apparatus 100.

The information processing apparatus 100 includes a processor 101, a main storage device (main storage) 102, an auxiliary storage device (auxiliary storage) 103, an input device 104, an output device 105 and a network interface (NIF) 106.

The input device 104 is a pointing device instanced by a keyboard, a mouse and other equivalent devices. The data inputted from the input device 104 is given to the processor 101. The output device 105 outputs a processing result of the processor 101. The output device 105 is, e.g., a display. The output device 105 can also include a sound output device instanced by a printer, a speaker and other equivalent devices.

The NIF 106 is an interface circuit for inputting and outputting the information from and to the network. The NIF 106 includes at least one of an interface connecting to a wired network and an interface connecting to a wireless network. The NIF 106 is exemplified by a network interface card (NIC), a LAN (Local Area Network) card, a wireless LAN card and other equivalent cards. The data and other equivalent items received by the NIF 106 are transferred to the processor 101.

The auxiliary storage device 103 stores various categories of programs and the data used for the processor 101 to run the programs. The auxiliary storage device 103 is configured by any one or a combination of nonvolatile memories instanced by the HDD, the SSD, the EEPROM and other equivalent storages. The auxiliary storage device 103 stores Operating System (OS), and a variety of application programs. The auxiliary storage device 103 may include a non-transitory portable recording medium such as a USB memory, and a non-transitory disk recording medium instanced by the CD, the DVD and the Blu-ray disc.

The main storage device 102 is used as a storage area into which the programs stored in the auxiliary storage device 103 are loaded, a work area for the processor 101 and a buffer area. The main storage device 102 is configured by, e.g., the RAM or a combination of the RAM and the ROM.

The processor 101 is, e.g., the CPU or the MPU. The processor 101 includes the DSP as the case may be. The processor 101 loads the various categories of programs stored in the auxiliary storage device 103 into the main storage device 102, and runs the programs. With this operation, the information processing apparatus 100 executes a variety of processes used for the information processing apparatus 100 to operate as the controller 1. A plurality of processors 101 may be provided without being limited to the single processor.

The processor 101 is one example of a “control unit” or “controller”. Each of the main storage device 102 and the auxiliary storage device 103 is one example of a “storage”, a “storage device” or a “non-transitory computer readable recording medium”. A part or a whole of processes to be executed by the processor 101 may be carried out by a hardware logic using a semiconductor device. At least one of a combination of a Programmable Logic Device (PLD) instanced by a Field Programmable Gate Array (FPGA), an Application Specific Integrated Circuit (ASIC), a Large Scale Integrated circuit (LSI) and an Integrated Circuit (IC), and an electric/electronic circuit, is selected for the semiconductor device.

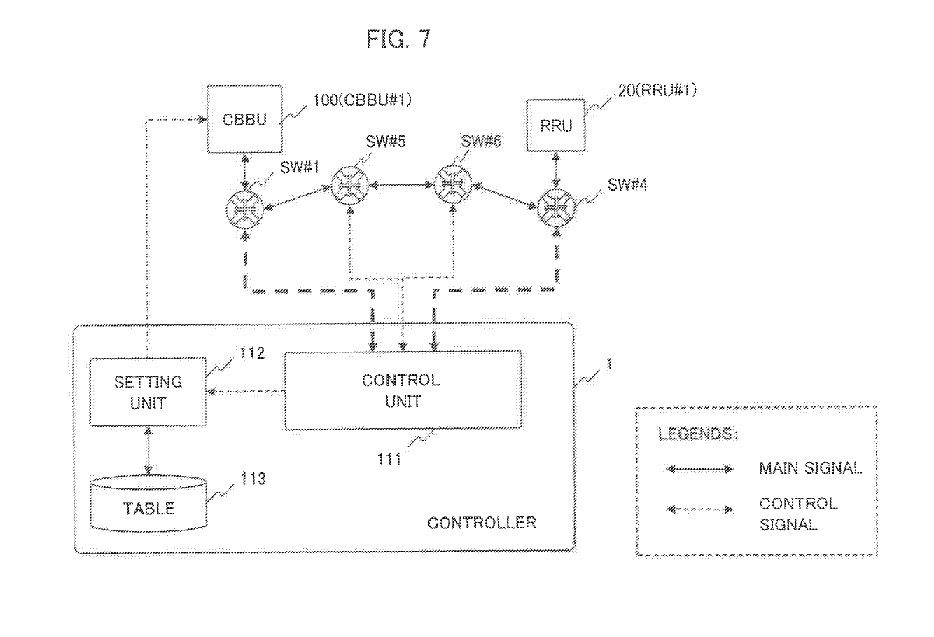

FIG. 7 is a diagram schematically illustrating functions of the controller 1. The processor 101 runs the programs, whereby the information processing apparatus 100 operates as an apparatus including a control unit 111, a setting unit 112 and a table 113.

The control unit 111, when a given CBBU (e.g., the CBBU#4) cannot receive the RRU (the RRU#1) (cannot set the RRU as the subordinate), obtains information indicating loads on the remaining CBBUs (CBBU#1-CBBU#3). The control unit 111 determines, based on the information indicating the loads, which CBBU (e.g., the CBBU#1) receives the RRU#1. This process can be also, however, executed by another information processing apparatus (computer) exclusive of the information processing apparatus 100.

The control unit 111 generates a control signal for setting a communication path (which will hereinafter be simply called a “route”) extending from the RRU#1 to the CBBU#1, and transmits the control signal to each of the SWs (SW#4, SW#6, SW#5, SW#1). With this setting, the route becomes a status of the signals being transmitted and received between the CBBU#1 and the RRU#1.

The control unit 111 instructs the SW#1 to transmit a signal for measuring the delay time (referred to simply as the “measurement signal”). The measurement signal is thereby transmitted to the SW#4 from the SW#1. The control unit 111 receives information indicating reception time of the measurement signal from the SW#4, and measures the delay time between the SW#1 and the SW#4. The delay time is given to the setting unit 112. Note that the controller 1 may receive transmission time of the measurement signal from the SW#1, and may measure the delay time from the transmission time and the reception time. The measured delay time is stored in at least one of the main storage device 102 and the auxiliary storage device 103.

The setting unit 112 refers to the table 113, and thus determines a protocol or specification used for the communications between the RRU#1 and the CBBU#1, corresponding to the delay time. The setting unit 112 supplies a variation instruction about the determined protocol or specification to the CBBU#1. The CBBU#1 varies the determined protocol or specification.

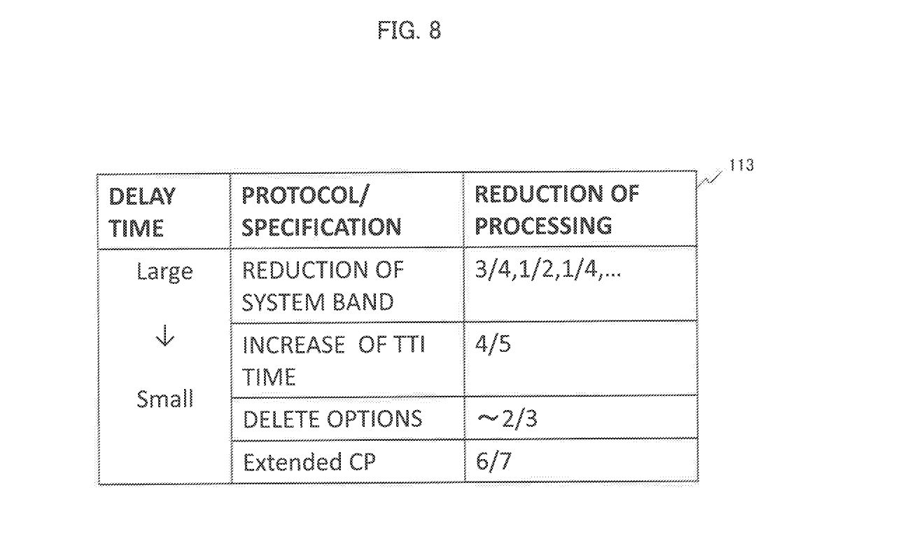

FIG. 8 illustrates an example of a data structure of the table 113. The table 113 stores contents of how the protocol or the specification varies like this: “Decrease in System Band”, “Increase in TTI Time (Relaxation in TTI time)”, “Deletion of Option” and “Extended CP Length (Extended CP)”, corresponding to a length of the delay time (Large [symbol] Small). The setting is that the CBBU can complete processing the signal given from the RRU within a requested period of time, depending on the variation of the protocol or the specification.

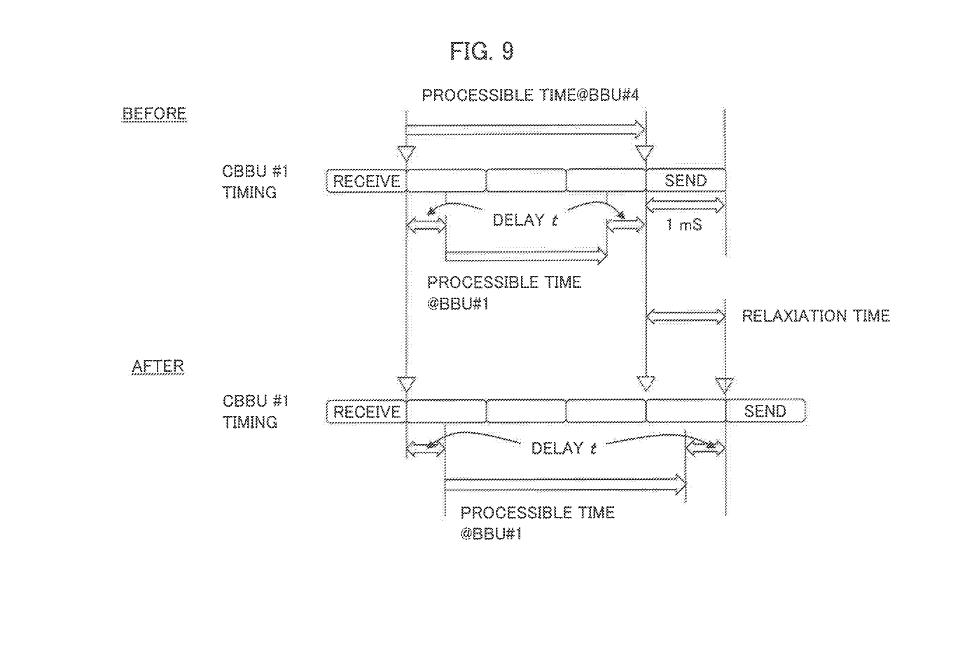

The description starts with “Increase in TTI time (Relaxation in TTI time)”. “TTI” is an abbreviation of “Transfer Time Interval” representing a data transmission interval. The TTI is one example of “restriction time”. FIG. 9 illustrates an example of how the processing time is ensured by the TTI relaxation. In FIG. 9, the time is indicated along a direction of the axis of abscissa. According to the LTE specification, normally a response about whether a data error exists in the data of a received subframe, is given in a fourth subframe counted from reception of the subframe (a length of one subframe is 1 ms) containing the data. In other words, the transmission of response is requested to be finished within four subframes.

It is assumed in “before relaxation” that the CBBU#4 receives the signal from the RRU#1, and the TTI is set in the four subframes. Hereat, supposing that the transmission of the response takes 1 ms, the CBBU#4 can use 3 ms (3 subframes) for processing the signal transmitted from the RRU#1 (refer to “processing enable time (processible time) @BBU#4”). By contrast, in the CBBU#1, a delay “t” occurs because of the signal arriving via the relay path, and the processible time of the signal shortens (refer to “processible time @#1”).

Herein, supposing that it requires 3 ms to process the signal, the CBBU#1 cannot transmit the response after finishing the process within the 4 subframes. Therefore, the controller 1 (the setting unit 112) increases the TTI length by varying the protocol. For example, as indicated by “after relaxation” in FIG. 9, the setting unit 112 determines the TTI to be increased by one frame. This increased TTI enables 3 ms to be ensured even when the delay “t” occurs, which is required for processing the signal, and consequently the CBBU#1 can normally transmit the response to the RRU#1. In other words, the process can be finished within the required period of time. Note that a time length (a length of relaxation time) to be added due to the increase can be properly set corresponding to the delay time. For example, the time length is varied on, e.g., a one-subframe basis.

Next, a description of “Extended CP length” will be made. According to the LTE, OFDM (Orthogonal Frequency-Division Multiplexing) is adopted as a digital modulation method. The OFDM has a mechanism called cyclic prefix (CP), in which a signal proximal to an end of one symbol is copied to a head of next symbol to guard the transmission data from multipath interference. The CP is provided in the guard interval for eliminating the interference between subcarriers due to symbol interference and a collapse of orthogonality between the subcarriers.

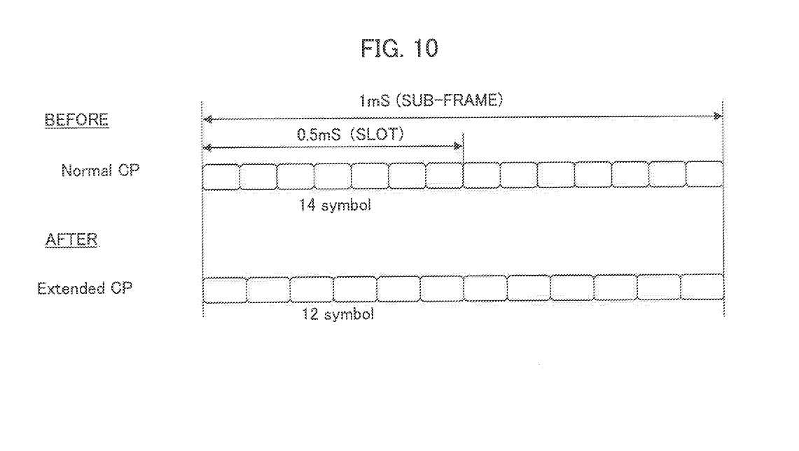

FIG. 10 is an explanatory diagram of how a load on the signal processing due to a variation in CP length is reduced. As illustrated in FIG. 10, when used in “Normal CP”, fourteen OFDM symbols are transmitted in one subframe (1 ms). The symbol represents a unit of the radio signal obtained as a result of modulating transmission target information bits having a given fixed length.

The setting unit 112 extends the CP length of each symbol, corresponding to the delay time, when “Normal CP” is used at the normal time (“before relaxation”). In other words, the setting unit 112 determines the use of “Extended CP” as the CP. When using “Extended CP”, a symbol count in one subframe is reduced down to “12”. Thus, the setting unit 112 can vary the protocol to reduce the symbol count in one subframe down to “12”, corresponding to the delay time. The reduction in symbol count implies a decrease in data quantity to be processed within the processible time. Hence, the CBBU#1 can finish processing within the processible time.

Next, a description of “Decrease in System Band” will be made. The use of the OFDM enables the system band (a bandwidth of the signal processible by the system (CBBU)) to be changed. According to the LTE, a maximum value of the system band is 20 MHz. The system band can be changed to 10 MHz, 5 MHz, 3 MHz and 1.4 MHz.

The setting unit 112 can determine the system band based on the system band at the normal time and the length of delay time. For example, the system band is 20 MHz at the normal time, and becomes ½ when changed to 10 MHz. A decrease in system band leads to a decrease in data quantity (subframe count) to be transmitted at one time. Consequently, a quantity of the data processed by the CBBU#1 is decreased. The signal processing time is thereby reduced, and the processing can be finished within the processible time.

Finally, a description of “Deletion of Option” will be made. The 3CPP Standards prepare an option function for improving wireless performance, and the CBBU#1 supports the option function concerning the signal processing at the normal time as the case may be. In this case, the setting unit 112 determines to set OFF the option function (vary the specification) corresponding to the delay time. The option function is set OFF, thereby decreasing the signal processing quantity and reducing the processing time as well. Consequently, the processing can be finished within the processible time. The option is one example of an “additional process”

The processing example of the table in FIG. 8 demonstrates an instance of implementing policies of “Decrease in System Band”, “Increase in TTI”, “Deletion of Option” and “Extended CP” corresponding to the length of delay time. It is not, however, an indispensable requirement to implement all of these policies, and it may be sufficient to implement at least one of the policies. A plurality of policies may also be implemented in parallel corresponding to the delay time. Note that “Process Reduction Effect” in FIG. 8 represents an example of the processing quantity to be reduced by varying the protocol or the specification. The table 113 may not contain data of “Process Reduction Effect”.

The table 113 is referred to when the delay time exceeds a predetermined threshold value, and, whereas when not exceeding the threshold value, the setting unit 112 may determine to continue using the protocol or the specification at the normal time (present time) (so as not to vary the protocol or the specification). Alternatively, the setting unit 112 may determine to continue using the current protocol or specification when the measured delay time is shorter than the minimum delay time stored in the table 113.

In the example illustrated in FIG. 8, the table 113 stores the policies corresponding to the delay time. In place of this configuration, the table 113 may store policies corresponding to the processing time that is deficient in the CBBU#1. In this case, the controller 1 obtains the information indicating a throughput from the CBBU#1, then acquires deficient processing time (deficient time) from the thus obtained information and the measured value of the delay time by using the setting unit 112, and obtains the policy enabling the deficient time to be ensured from the table 113. The contents of the protocol or the specification corresponding to the delay time may be thus determined. Note that the variation contents of the protocol or the specification are an exemplification, and the embodiment is not limited these variation contents.

Note that the control unit 111 and the setting unit 112 are the functions of the processor 101, and these functions are acquired by the processor 101 running the programs. The table 113 is stored in at least one of the main storage device 102 and the auxiliary storage device 103.

### Operational Example

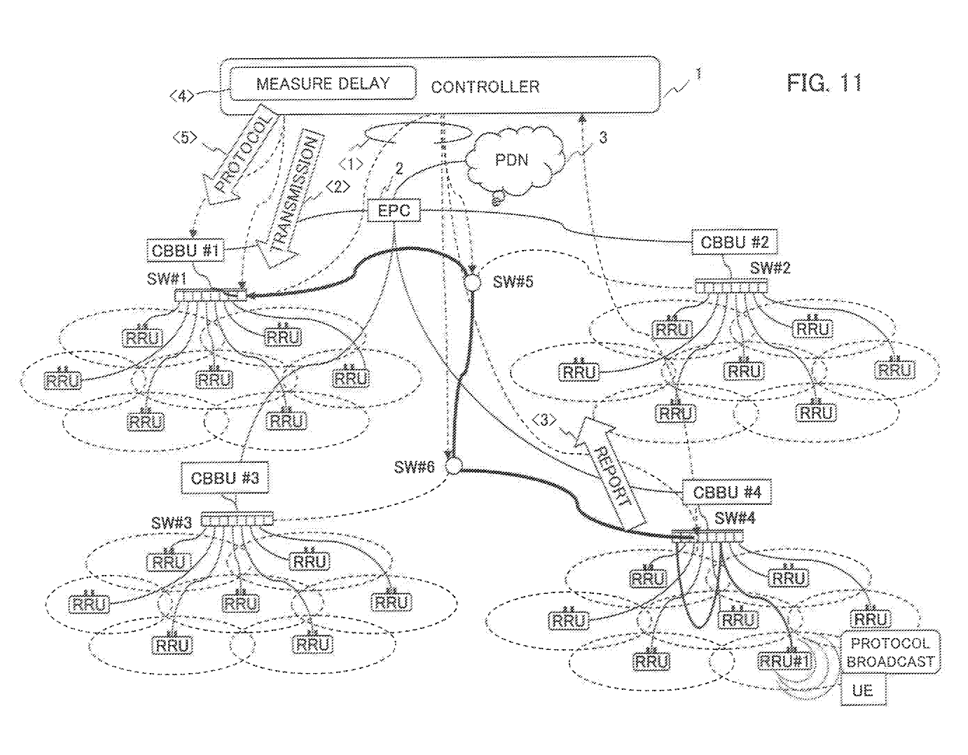

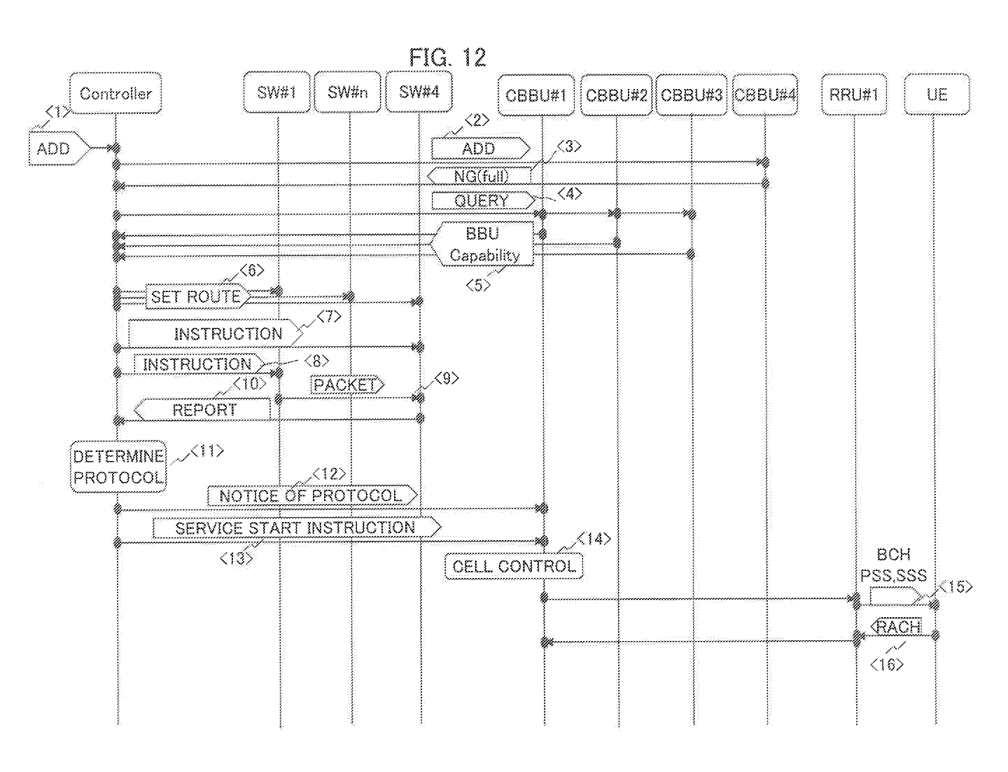

FIG. 11 is a diagram illustrating an operational example in the network system according to the embodiment illustrated in FIG. 4. FIG. 12 is a sequence diagram illustrating an operational example of the embodiment. The operational example will hereinafter be described with reference to FIGS. 11 and 12.

In FIG. 12, the host apparatus (e.g., an operator) instructs the controller 1 to start a service (add the cell) for the RRU#1 (FIG. 12<1>). Upon receiving the instruction, the controller 1 transmits, to the CBBU#4, a query (a cell adding request) about whether the service for the RRU#1 can be started (received) (FIG. 12<2>).

When the CBBU#4 can start the service, the CBBU#4 transmits a response of its being able to start the service back to the controller 1, and can thus start the service. By contrast, when having no surplus power to process the signals coming from the RRU#1 due to the congestions of the processes of the subordinate RRUs (cell), the CBBU#4 sends a response (disabled (full capacity reached)) purporting that the service is disabled from starting to the controller 1 (FIG. 12<3>). This response is one example of “information indicating a deficiency of process resources”.

The controller 1 sends, to the CBBU#1-CBBU#3, a query (a load status report instruction) about whether the remaining CBBU#1-CBBU#3 can execute the processes of the RRU#1 (FIG. 12<4>). Each of the CBBU#1-CBBU#3 gives a response about the processibility (a load status report) (FIG. 12<5>). For example, each of the CBBU#1-CBBU#3 sends, when having the surplus power, the processibility response containing the information on its own throughput to the controller 1.

The controller 1 determines which CBBU receives the RRU#1 by referring to the load status report. In the examples of FIGS. 11 and 12, the CBBU#1 is determined to receive the RRU#1. The controller 1 sets the route so that the RRU#1 connects to the CBBU#1 (FIG. 12<6>, FIG. 11<1>). To be specific, the controller 1 sends a route setting instruction to the SW#4, SW#1, SW#n (SW#6,SW#5), and each SW sets the output port for the signals.

The controller 1 instructs the SW#4, to which the RRU#1 is connected, to report the time of receiving the measurement packet to the controller 1 when receiving a packet for measuring the delay time (the measurement packet (measurement signal) (FIG. 12<7>).

The controller 1 instructs the SW#1 to transmit the measurement packet at designated time to the SW#4 (FIG. 12<8>, FIG. 11<1>). The SW#1 generates and transmits the measurement packet (FIG. 12<9>). The SW#4, upon receiving the measurement packet, reports the reception time thereof to the controller 1 (FIG. 12<10>, FIG. 11<3>).

The controller 1 measures (calculates) the delay time by use of the transmission time (designated time) of the measurement packet and the reported reception time (FIG. 11<4>) Subsequently, the controller 1 obtains the processing time that is deficient when the CBBU#1 executes the process of the remote RRU#1 from the information on the throughput reported from the CBBU#1 and from the delay time, and determines the protocol or the specification that can compensate this deficient processing time (FIG. 12<11>).

The process in FIG. 12<11> can be determined by obtaining the policy corresponding to the deficient processing time from the table 113. Alternatively, as described above, the policy (the post-varying protocol or specification) corresponding to the delay time can be also determined by being obtained from the table 113. The information on the throughput contains the contents (TTI, CP length, system band, ON/OFF of option) of the current protocol or specification, and the implementable policy may also be extracted from the table 113.

The controller 1 notifies the CBBU#1 of the information indicating the determined policy (the protocol or the specification) (FIG. 12<12>, FIG. 11<5>). The controller 1 sends a server start instruction to the CBBU#1 (FIG. 12<13>). The CBBU#1 having received the information indicating the policy and the service start instruction starts controlling (cell control) the RRU#1, based on the designated protocol or specification (FIG. 12<14>). For example, the CBBU#1 starts the communications based on the protocol with a TTI Standard value being relaxed as the notification indicates.

The start of the cell control triggers a start of transmission of broadcasting channel (BCH) and transmission of synchronization signals (PSS (Primary Synchronization Signal) and SSS (Secondary Synchronization Signal)) from, e.g., the CBBU#1 (FIG. 12<15>). The UE receiving the broadcasting channel and the synchronization signals starts a random access procedure (transmits a random access channel (RACH)) (FIG. 12<16>). The UE identifies the protocol or the specification applied in the RRU#1 from the information of the broadcasting channel, and can start the communications.

### Processing Example of Controller

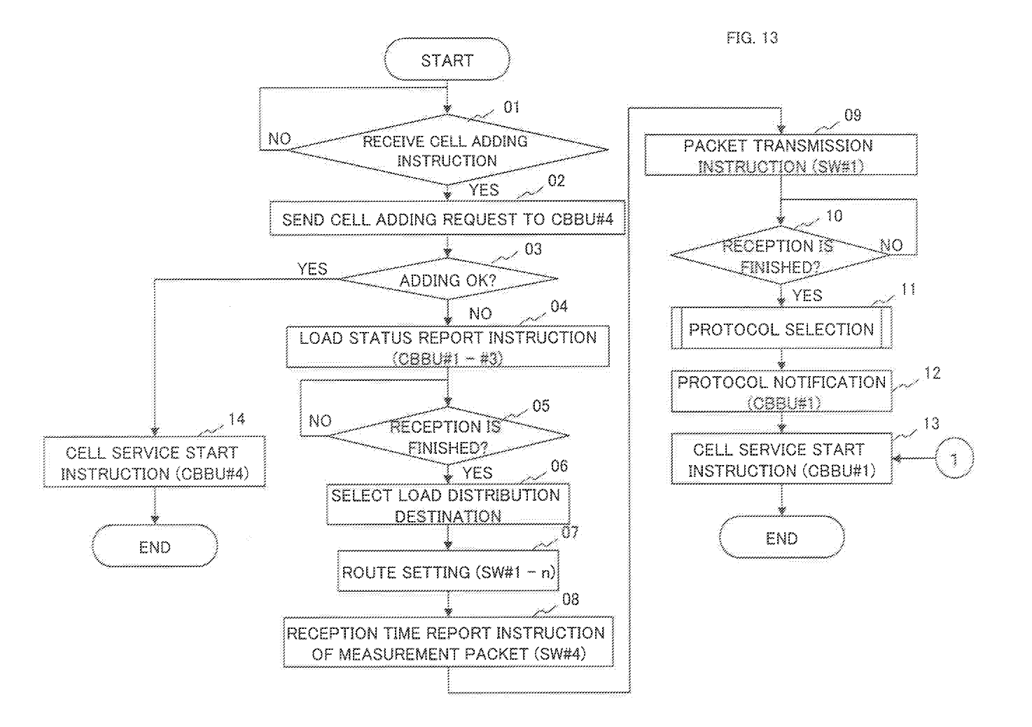

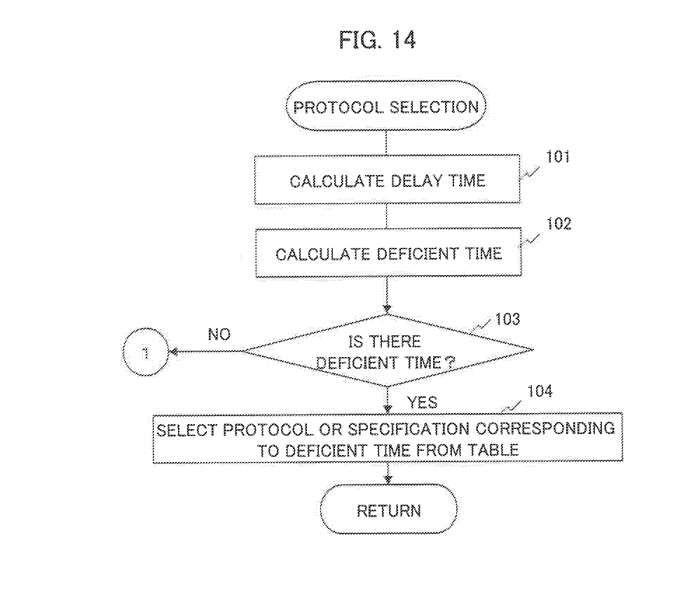

FIG. 13 illustrates a processing example of the controller 1, and FIG. 14 illustrates one example of a protocol selection process depicted in FIG. 13. The processor 101 operating as the control unit 111 and the setting unit 112 executes processes illustrated in FIG. 13.

In 01, the processor 101 waits a cell adding instruction. When receiving the cell adding instruction (Yes in 01), the processor 101 sends a cell adding request to the cell adding target CBBU#4 (02).

In next 03, the processor 101 determines, upon receiving a response to the cell adding request from the CBBU#4, whether the cell can be added or not. Hereat, when the cell can be added (Yes in 03), the processor 101 executes a process of transmitting a cell server start instruction to the CBBU#4 (14). Whereas when the cell cannot be added (No in 03), the processor 101 executes a process of transmitting a load status report instruction to the CBBU#1-CBBU#3 (04).

In 05, the processor 101 waits a load status report from each of the CBBU#1-CBBU#3. When completing the reception of the load status report (Yes in 05), the processor 101 selects a load distribution destination (06). For example, the CBBU#1 is selected.

In 06, the processor 101 sets the route between the CBBU#1 and the RRU#1 (07). In other words, the processor 101 executes a process of transmitting the control signal for setting the route to the switches SW#1, SW#4, SW#5 and SW#.

In 08, the processor 101 executes a process of sending a reception time report instruction of the measurement packet to the SW#4. In next 09, the processor 101 executes a process of sending a measurement packet transmission instruction at the designated time to the SW#1.

In 10, the processor 101 waits for the reception time of the measurement packet to come from the SW#4. When reaching the completed reception of the reception time (Yes in 10), the processor 101 executes a protocol selection process (11).

In FIG. 14, the processor 101 calculates the delay time from the reception time and the designated time (transmission time) (101). Subsequently, the processor 101 calculates the deficient time from performance information and the delay time in the load status report received from the CBBU#1 (102).

In 103, the processor 101 determines whether the deficient time exists. When the deficient time does not exist (No in 103), the processor 101 advances the processing to 13, and causes the CBBU#1 to start the cell service. In this case, the TTI, the CP length, the system band and the ON-status of the option are maintained. Whereas when the deficient time exists (Yes in 103), the processor 101 obtains the policy (the variation content of the protocol or the specification) corresponding to the deficient time from the table 113 (104) Thereafter, the processing advances to 12.

In 12, the processor 101 executes a process of notifying the CBBU#1 of the protocol or the specification pertaining to the variation. In 13, the processor 101, as described above, gives the cell service start instruction to the CBBU#1.

### Effect of Embodiment

According to the embodiment, when there occurs the deficiency of the process resources used for the CBBU#4 to process the signals coming from the RRU#1, the CBBU#1 to receive the RRU#1 is determined in place of the CBBU#4. Hereat, when there occurs the deficiency of the time enabling the CBBU#1 to process the signals coming from the RRU#1, the protocol or the specification for ensuring the signal processible time is determined to vary, and the CBBU#1 performs the communications with the RRU#1 based on the varied protocol or specification. The normal communications between the CBBU and the RRU can be thereby performed.

According to the embodiment, it is feasible to avoid enhancing the performance of the CBBU to ensure the signal processing time. A cost for introducing the CBBUs can be thereby restrained from rising. The embodiment also enables the process resources to be distributed between the CBBUs distanced from each other. With this distribution, a greater number of CBBUs can share the processes resources for the signals coming from the RRUs, whereby a large number of cells can be received with a smaller quantity of process resources. The cost for introducing the CBBUs can be thereby restrained from rising.

Not only the neighboring CBBU but also the CBBU having a less possibility of suffering from a remote damage can be used, whereby a securer system can be built up.

### Modified Example

The embodiment discussed above can be modified as follows. For example, in the embodiment, there is measured the delay time of a route segment between the SW#1 and the SW#4 as a predetermined route segment of the communication route between the CBBU#1 and the RRU#4. However, the route segment for measuring the delay may be any other than the example. For instance, the delay time may be measured between any two SWs selected from, e.g., SW#1, SW#5, SW#6 and SW#4. Alternatively, the delay time between the CBBU#1 and the RRU#1 may also be measured. In other words, the predetermined route segment may be a part of the communication route and may also be a whole of the communication route.

The embodiment has discussed the configuration of establishing the connection between the CBBUs each receiving the plurality of RRUs by the relay path. As a matter of course, the controller 1, when the RRU is added to a given CBBU (e.g., the CBBU#1), measures the delay time in the predetermined route segment of the communication route between the CBBU and the RRU, and may vary the protocol or the specification corresponding to the delay time. To be specific, the RRU located in a remote place is connected inevitably via the SW#1 to the given CBBU (e.g., the CBBU#1), in which case the controller 1 may vary the protocol or the specification corresponding to the delay time between the CBBU and the RRU. In this case, for instance, the controller 1 instructs the CBBU to transmit the measurement packet, and instructs the RRU to report the reception time of the measurement packet so that the delay time between the CBBU and the RRU is measured. Alternatively, RTT (Round Trip Time) between the CBBU and the RRU is measured, and a half value of the RTT may be reported as the delay time to the controller 1.

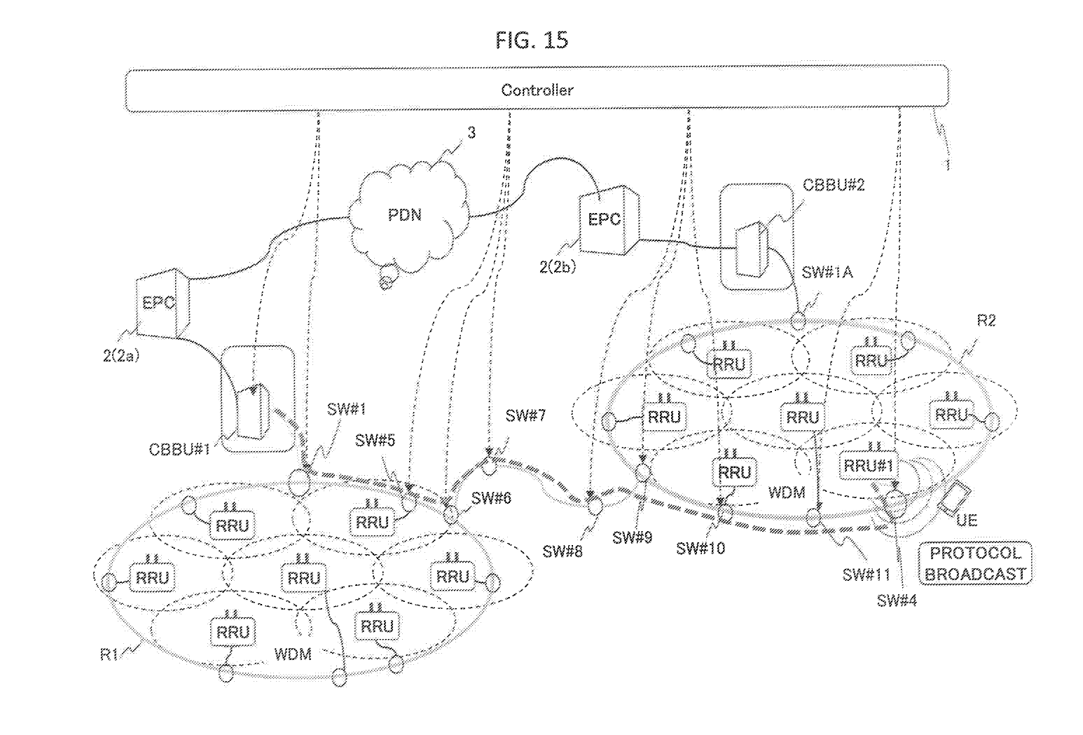

FIG. 15 illustrates a modified example 1 of the embodiment. The network configuration depicted in FIG. 4 is the tree network topology of connecting the RRUs and the CBBUs. By contrast, as illustrated in FIG. 15, a ring topology can be also adopted, in which the RRUs are connected to a WDM (Wavelength Division Multiplexing) ring via the switches (SWs), and WDM ring is connected to the CBBU via one of these switches.

In the example of FIG. 15, the switches (SWs) connected to the RRUs are connected to the ring network (WDM ring) R1, and one (SW#1) of these switches is connected to the CBBU#1. The CBBU#1 is connected to a PDN 3 via an EPC apparatus 2a. The switches (SWs) connected to the RRUs are connected also to a ring network R2, and one (SW#1A) of the switches is connected to the CBBU#2. The CBBU#2 is connected to the PDN 3 via an EPC apparatus 2b.

The ring network R1 is connected via the relay path to the ring network R2. Specifically, the SW#6 on the ring network R1 is connected to the SW#9 on the ring network R2 via the SW#7 and the SW#8 on the relay path. When the RRU#1 becomes a subordinate to the CBBU#1, the controller 1 sets the route for connecting the RRU#1 to the CBBU#1 with respect to the SW#1, SW#4 and the SW#5-SW#11 located between the SW#1 and the SW#4. Other processes are the same as in the embodiment, and hence their explanations are omitted.

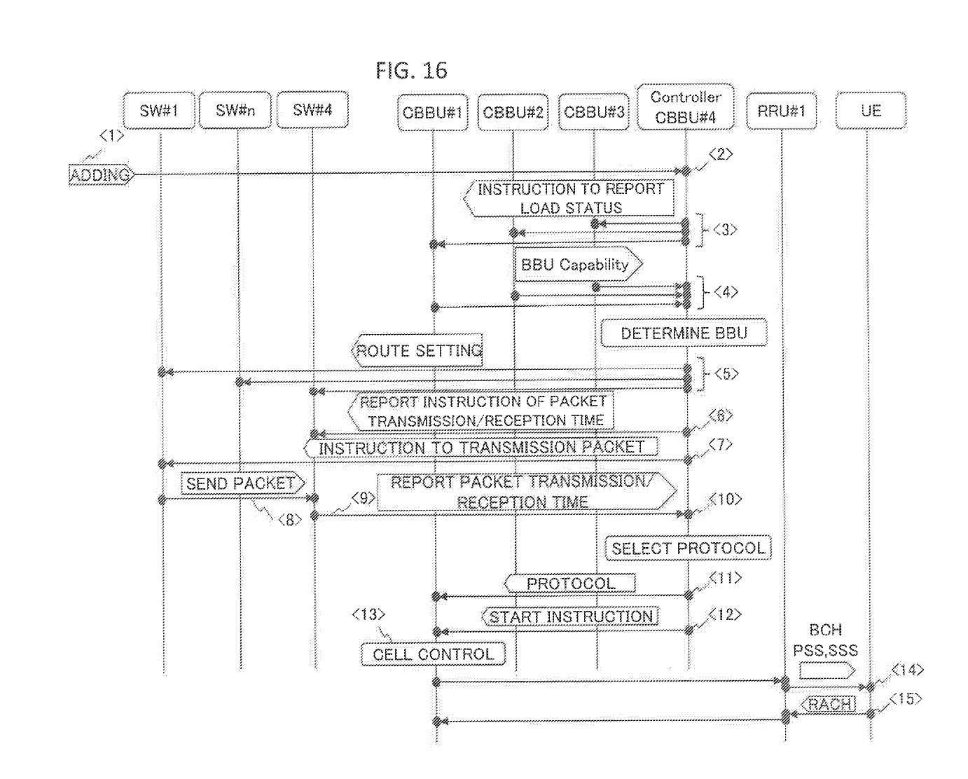

FIG. 16 is a sequence diagram illustrating a modified example 2 of the embodiment. The embodiment has discussed a mode in which the controller 1 is the apparatus independent of the CBBU. In this respect, however, the functions of the controller 1 can be implemented into the CBBU. In this case, the memory 12 of the CBBU 10 stores a program used for the processor 101 to execute the processes, and the CPU 11 runs the program to execute the same processes as those of the processor 101. The LSI 13 can also execute a part or a whole of the processes to be executed by the CPU 11.

FIG. 16 is a sequence diagram illustrating an operational example when the CBBU#4 in the embodiment includes the controller 1. The network topology in the sequence is the same as the topology depicted in FIG. 11. However, the topology is different from FIG. 11 in terms of the CBBU#4 including the controller 1.

In FIG. 16, the host apparatus (e.g., the operator) instructs the CBBU#4 to start the service (to add the cell) for the RRU#1 (FIG. 16<1>). The CPU 11 of the CBBU#4 having received the instruction determines whether the service for the RRU#1 (the reception of the RRU#1) can be started (FIG. 16<2>). Hereat, when the service can be started, the CBBU#1 starts the cell service pertaining to the RRU#1.

Whereas when the CBBU#4 has no surplus power to process the signals coming from the RRU#1, the CBBU#4 sends, to the remaining CBBU#1-CBBU#3, a query (the load status report instruction) about whether these CBBUs can execute the processes of the RRU#1 (FIG. 16<3>). Each of the CBBU#1-CBBU#3 makes a response about the processibility (the load status report) (FIG. 16<4>).

The CBBU#4 determines which CBBU (the CBBU#1) receives the RRU#1 by referring to the load status report. The CBBU#4 sets the route so that the RRU#1 is connected to the CBBU#1 (FIG. 16<5>). To be specific, the CBBU#4 sends the route setting instruction to the SW#4, SW#1, SW#n(SW#6, SW#5), and each SW sets the output port for the signals.

The CBBU#4 instructs the SW#4, to which the RRU#1 is connected, to report the reception time of the measurement packet to the CBBU#4 when receiving the measurement packet. (FIG. 16<6>).

The CBBU#4 instructs the SW#1 to transmit the measurement packet to the SW#4 at the designated time (FIG. 16<17>). The SW#1 generates and transmits the measurement packet (FIG. 16<8>). The SW#4, upon receiving the measurement packet, reports the reception time thereof to the controller 1 (FIG. 16<9>).

The CBBU#4 measures (calculates) the delay time from the transmission time (the designated time) of the measurement packet and from the reported reception time thereof. Subsequently, the CBBU#4 obtains the deficient processing time from the information about the throughput reported from the CBBU#1 when the CBBU#1 executes the processes of the remote RRU#1. The CBBU#4 determines the protocol or the specification enabling the deficient processing time to be compensated (“selection of protocol” in FIG. 16<10>). The process in FIG. 16<10> is the same as the process in FIG. 12<11>, and hence its explanation is omitted.

The CBBU#4 notifies the CBBU#1 of the information indicating the determined protocol or specification (FIG. 16<11>), and simultaneously sends the service start instruction to the CBBU#1 (FIG. 16<12>). The CBBU#1 having received the service start instruction starts controlling (the cell control) the RRU#1, based on the designated protocol or specification (FIG. 16<13>). For example, the CBBU#1 starts the communications based on the protocol with the TTI Standard value being relaxed as the notification indicates.

The start of the cell control triggers the start of transmission of the broadcasting channel (BCH) and transmission of synchronization signals (PSS and SSS) from, e.g., the CBBU#1 (FIG. 16<14>). The UE receiving the broadcasting channel and the synchronization signals starts the random access procedure (transmits the random access channel (RACH)) (FIG. 16<15>). The UE identifies the protocol or the specification applied in the RRU#1 from the information of the broadcasting channel, and can start the communications.

The same effects as those of the embodiment can be acquired by the modified examples 1 and 2. The configurations of the embodiment discussed above can be properly combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus of a base station, comprising:
a controller configured to execute a process including measuring delay time of a signal in a predetermined route segment of a communication route between a radio apparatus and a baseband apparatus to process the signal coming from the radio apparatus, and determining at least one of a protocol and a specification used for the communication between the baseband apparatus and the radio apparatus in response to the delay time.

2. The control apparatus of the base station according to claim 1, wherein the controller is configured to determine a length of restriction time till the baseband apparatus responds to the signal received from the radio apparatus in response to the delay time.

3. The control apparatus of the base station according to claim 1, wherein the controller is configured to determine a length of a cyclic prefix of the signal received by the baseband apparatus from the radio apparatus in response to the delay time.

4. The control apparatus of the base station according to claim 1, wherein the controller is configured to determine a system band in response to the delay time.

5. The control apparatus of the base station according to claim 1, wherein the controller is configured to determine an ON/OFF status of an additional process for the signal received by the baseband apparatus from the radio apparatus.

6. The control apparatus of the base station according to claim 1, wherein the controller is configured to measure, when the radio apparatus is connected via a plurality of switches to the baseband apparatus, the delay time between the two switches selected from the plurality of switches.

7. The control apparatus of the base station according to claim 6, wherein the controller is configured to transmit, when receiving information indicating deficiency of process resources from another baseband apparatus connected to the radio apparatus, an instruction of changing over a connecting destination of the radio apparatus to the baseband apparatus to the plurality of switches, and is configured to start measuring the delay time of the signal between the two switches.

8. A baseband apparatus to process a signal coming from a radio apparatus, comprising:
a controller configured to execute a process including measuring delay time of a signal in a predetermined route segment of a communication route to a radio apparatus, and determining at least one of a protocol and a specification used for the communication with the radio apparatus in response to the delay time.

9. A control method of a base station, comprising:
measuring, by a controller of the base station, delay time of a signal in a predetermined route segment of a communication route between a radio apparatus and a baseband apparatus to process the signal coming from the radio apparatus; and
determining, by a controller of the base station, at least one of a protocol and a specification used for the communication between the baseband apparatus and the radio apparatus in response to the delay time.

10. A control method of a base station including a radio apparatus and a baseband apparatus to process a signal coming from the radio apparatus, the method comprising:
measuring, by a controller of the baseband apparatus, delay time of a signal in a predetermined route segment of a communication route to the radio apparatus; and
determining, by the controller of the baseband apparatus, at least one of a protocol and a specification used for the communication between the baseband apparatus and the radio apparatus in response to the delay time.
